(19) United States
(12) Patent Application Publication
(10) Pub. No.: US 2005/0086219 A1
(43) Pub. Date: Apr. 21, 2005

(54) Generation of keywords for searching in a computer network

(75) Inventor: Anthony G. Martin, Los Altos, CA (US)

Correspondence Address: OKAMOTO & BENEDICTO, LLP, P.O. BOX 641330, SAN JOSE, CA, 95164, US

(73) Assignee: Claria Corporation

(21) Appl. No.: 11/006,933

(22) Filed: Dec. 8, 2004

Related U.S. Application Data
(63) Continuation-in-part of application No. 10/464,418, filed on Jun. 17, 2003.
(60) Provisional application No. 60/457,268, filed on Mar. 25, 2003.
(60) Provisional application No. 60/618,911, filed on Oct. 14, 2004.

(51) Int. Cl. G06F 17/30

(52) U.S. Cl. 707/3

(57) ABSTRACT

In one embodiment, search results are generated in a computer network by detecting an end-user interaction with a document, generating a keyword based on the end-user interaction with the document, and performing a search using the keyword. The computer network may include the Internet and the document may be a web page. For example, a program running on a client computer may monitor the end-user's browsing activities on the Internet. When the end-user clicks on a link, information associated with the link, such as the link's label, may be parsed to generate one or more keywords. The keywords may be used to perform a search to generate search results responsive to the keywords.

### CROSS-REFERENCE TO RELATED APPLICATIONS

This application claims the benefit of U.S. Provisional Application No. 60/618,911, filed on Oct. 14, 2004, which is incorporated herein by reference in its entirety.

This application is a continuation-in-part of U.S. application Ser. No. 10/464,418, filed on Jun. 17, 2003, which claims the benefit of U.S. Provisional Application No. 60/457,268, filed on Mar. 25, 2003, both of which are incorporated herein by reference in their entirety.

### BACKGROUND OF THE INVENTION

1. Field of the Invention

The present invention relates generally to computer systems, and more particularly but not exclusively to methods and associated systems for generating keywords for performing searches in a computer network.

2. Description of the Background Art

Use of the Internet for making commercial transactions has become commonplace and continues to grow. Due to the number and variety of websites offering goods and services over the Internet—and information relating to goods and services—using the Internet as a means for pursuing commercial opportunities can be inefficient. For example, an end-user searching for special offers, discounts, and new products over the Internet may be overwhelmed with irrelevant advertisements. These advertisements are typically provided by server computers having no intelligence as to the interests of the end-user. Thus, most advertisements displayed to the end-user are irrelevant to the end-user, and only of fortuitous interest to the end-user.

Internet search engines, such as Yahoo! and Google, have taken advantage of end-user searches by providing so-called “sponsored links” along with search results. These sponsored links are typically paid advertisements for particular keywords used in a search. For example, a car advertiser may pay a search engine to be included in search results for the keyword “car.” Although search results allow for targeted advertising, conventional search-related advertising campaigns are somewhat limited in that an end-user must actually be performing a search before sponsored links can be delivered to him.

### SUMMARY

In one embodiment, search results are generated in a computer network by detecting an end-user interaction with a document, generating a keyword based on the end-user interaction with the document, and performing a search using the keyword. The computer network may include the Internet and the document may be a web page. For example, a program running on a client computer may monitor the end-user's browsing activities on the Internet. When the end-user clicks on a link, information associated with the link, such as the link's label, may be parsed to generate one or more keywords. The keywords may be used to perform a search to generate search results responsive to the keywords.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a flow diagram illustrating a method of providing a search result in accordance with an embodiment of the present invention.

FIG. 2 shows a schematic diagram of a computer network in accordance with an embodiment of the present invention.

FIG. 3 shows a flow diagram schematically illustrating generation and presentation of search results in accordance with an embodiment of the present invention.

FIG. 4 shows a presentation vehicle for displaying search results in accordance with an embodiment of the present invention.

FIG. 5 schematically illustrates the components of a client computer in accordance with an embodiment of the present invention.

FIG. 6 schematically illustrates the components of a message server computer in accordance with an embodiment of the present invention.

FIG. 7 shows an example document available over a computer network.

FIG. 8 schematically illustrates the components of a message delivery program in accordance with an embodiment of the present invention.

FIG. 9 shows a flow diagram of a method of performing a search in a computer network in accordance with an embodiment of the present invention.

FIG. 10 shows a flow diagram illustrating generation of keywords for searching in a computer network, in accordance with an embodiment of the present invention.

FIGS. 11A, 11B, and 11C pictorially illustrate the generation of search results in accordance with an embodiment of the present invention.

The use of the same reference label in different drawings indicates the same or like components.

### DETAILED DESCRIPTION

In the present disclosure, numerous specific details are provided, such as examples of systems, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

It is to be noted that although embodiments of the present invention are described herein in the context of delivering and receiving advertisements over the Internet, the present invention is not so limited and may be used in other data processing applications.

An end-user navigating on the Internet may encounter a variety of messages, such as advertisements displayed in pop-unders, pop-ups, banners, and other types of presentation vehicles. However, unless they specifically target the needs of the end-user, these messages will largely go unnoticed. Also, delivery of most messages on the Internet is somewhat limited as it relies on server-side technology, thus requiring the end-user to be on a specific website to receive the message. This requires an advertiser to contract with multiple websites in order to obtain a large audience. In addition, most of these messages are individually delivered to the end-user, thus cluttering the end-user's computer screen.

Some embodiments of the present invention alleviate the aforementioned problems associated with conventional message delivery by generating search results based on addressing information. In one embodiment, a client program resident in a client computer monitors an end-user's web browsing activity. The client program may be configured to trigger delivery of search results to the client computer when the end-user goes to a website in a category of websites. The search results may be responsive to one or more keywords derived from addressing information, such as the uniform resource locator (URL) of a website visited by the end-user.

By employing a client program, search results may be delivered to the end-user across a category of websites instead of from one particular website. That is, the client program (as opposed to a server program) is operable to trigger reception of messages across different websites. In addition, by performing a search on a keyword derived from addressing information, which is entered by the end-user, the probability that the end-user would have an interest in the search results is advantageously increased. Furthermore, using a search result format advantageously allows for several advertisements and other information to be displayed in a single presentation vehicle, thus minimizing clutter on the end-user's computer screen.

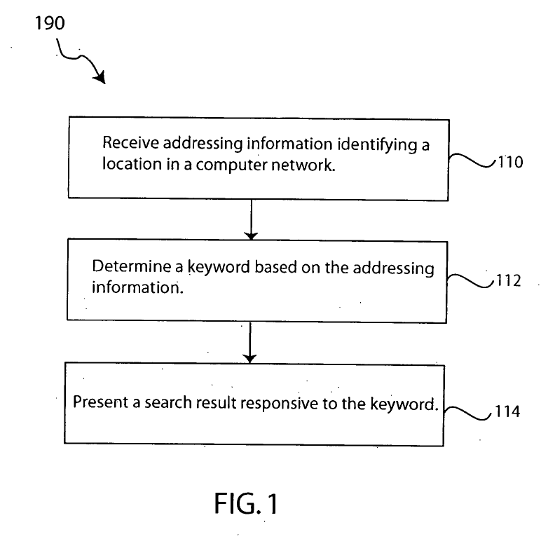

Referring now to FIG. 1, there is shown a flow diagram illustrating a method 190 of providing a search result in accordance with an embodiment of the present invention. In step 110, a client program receives addressing information identifying a location in a computer network. The location may be that of a website or a specific web page of the website visited by the end-user on the Internet. The addressing information may comprise a URL identifying the website or specific web pages of the website. The client program may receive the URL as an event notification from a web browser employed by the end-user, for example. For purposes of the present disclosure, the terms “website” and “web page” may be interchangeably used when referring to a specific location on the Internet.

In step 112, a keyword based on the addressing information is determined. In one embodiment, websites are categorized and then assigned one or more keywords. For example, websites relating to computers may be assigned the keyword “computer”. Specific web pages of a website may also be assigned more particular keywords. For example, the printer section of a computer-related website may be assigned the keywords “computer” and “printer”, or the phrase “computer printer”. A human operator may thus categorize popular websites on the Internet, assign a keyword for each category of websites, and enter the URL of the categorized websites along with their respective keywords in a database. The database may be a commercially available database program, a spreadsheet, a text file, or some other data storage and retrieval mechanism.

Determining the keyword (or keywords) assigned to each category of websites may be performed by the client program, or a server program in communication with the client program. For example, the client program may obtain the URL of a website visited by the end-user, and then provide the URL to the server program. The server program may then consult a database to determine at least one keyword assigned to the URL. The client program may also consult a local (i.e., resident in the client computer) database to determine at least one keyword assigned to the URL.

In step 114, the client program presents the end-user a search result(s) responsive to the keyword determined in step 112. For example, the keyword may be provided to a search engine that can perform a search on the keyword. The search result may be posted by the search engine on a designated web page. In the client computer, the client program may create or initiate the creation of a window (e.g., another browser window) pointed to the designated web page. This allows the end-user to view the search result.

Techniques for providing search results to end-users are also disclosed in commonly-assigned U.S. application Ser. No.10/289,123, filed on Nov. 5, 2002 and U.S. application Ser. No.10/815,112, filed on Mar.31, 2004, both of which are hereby incorporated by reference in their entirety. After a keyword has been derived from addressing information, search results may also be obtained using techniques similar to those disclosed in the just mentioned U.S. applications.

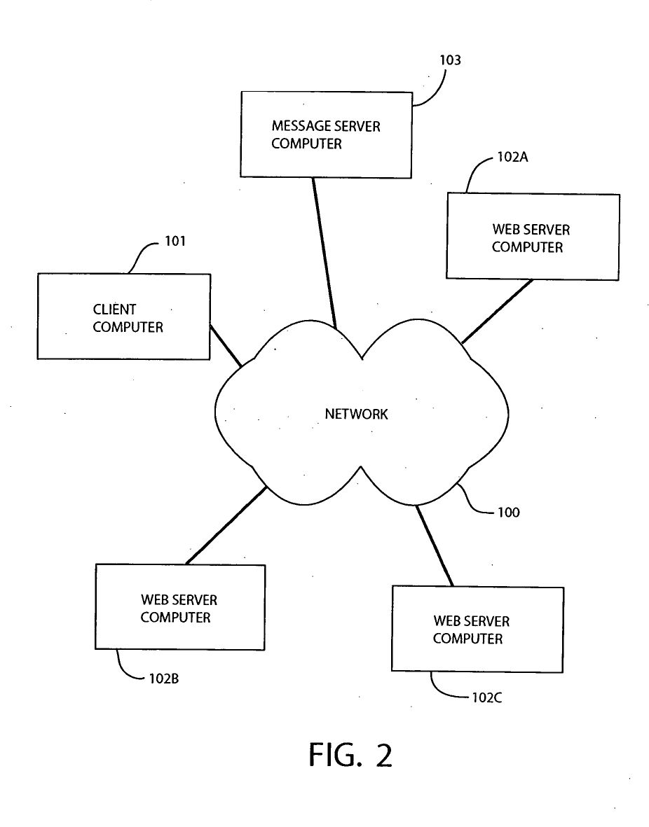

Referring now to FIG. 2, there is shown a schematic diagram of a computer network 100 in accordance with an embodiment of the present invention. Network 100 may include one or more client computers 101, one or more web server computers 102 (i.e., 102A, 102B, . . . ), one or more message server computers 103, and other computers not shown. Intermediate nodes such as gateways, routers, bridges, Internet service provider networks, public-switched telephone networks, proxy servers, firewalls, and other network components are not shown for clarity. In the example of FIG. 2, network 100 includes the Internet; however, other types of computer networks may also be used. Computers may be coupled to network 100 using any type of connection without detracting from the merits of the present invention.

A client computer 101 is typically, but not necessarily, a personal computer such as those running the Microsoft Windows™, Apple Macintosh™, Linux, or UNIX operating systems. An end-user may employ a suitably equipped client computer 101 to get on network 100 and access computers coupled thereto. For example, a client computer 101 may be used to access web pages from a web server computer 102. It is to be noted that as used in the present disclosure, the term “computer” includes any type of data processing device including personal digital assistants, digital telephones, wireless terminals, video game consoles, and the like.

A web server computer 102 may be a website containing information designed to attract end-users surfing on the Internet. A web server computer 102 may also include advertisements, downloadable computer programs, and products available for online purchase. A web server computer 102 may also be an ad server for delivering advertisements to a client computer 101. A web server computer 102 may include a search engine for making a local search (i.e., within a domain) or an Internet search.

A message server computer 103 may include the functionalities of a web server computer 102. Additionally, in one embodiment, a message server computer 103 may also include message units for delivery to a client computer 101. The message units, which are further described below, may contain advertisements, for example. A message server computer 103 may also include downloadable computer programs and files for supporting, updating, or maintaining components in a client computer 101.

Web server computers 102 and message server computers 103 are typically, but not necessarily, server computers such as those available from Sun Microsystems, Hewlett-Packard, or International Business Machines. A client computer 101 may communicate with a web server computer 102 or a message server computer 103 using client-server protocol. It is to be noted that client-server computing is well known in the art and will not be further described here. It is to be further noted that for purposes of the present disclosure, a computer may be a single computer or a network of computers (e.g., a distributed computer system).

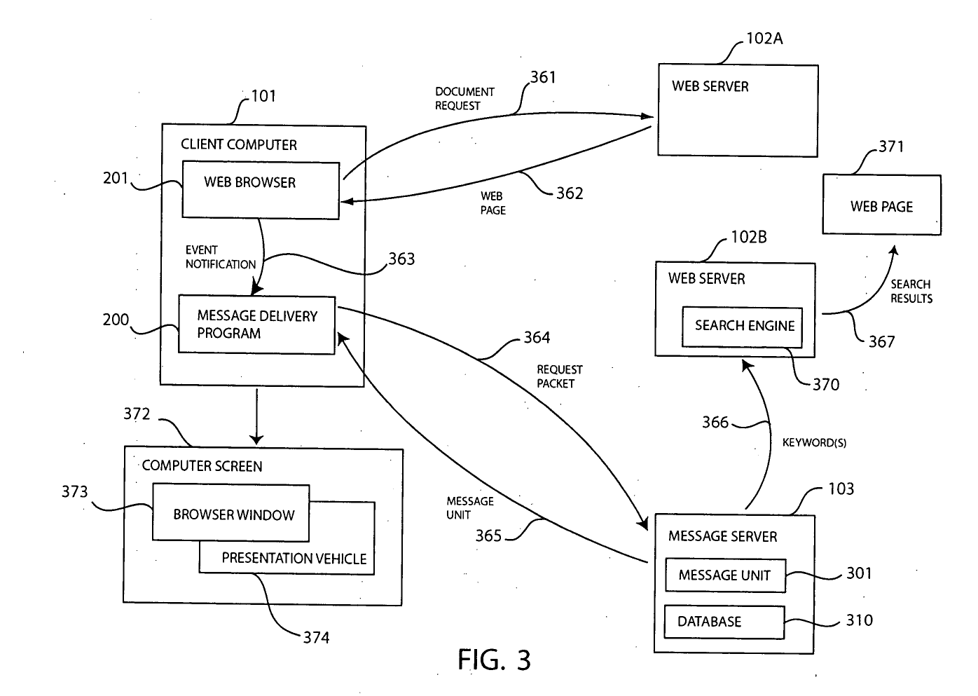

FIG. 3 shows a flow diagram schematically illustrating generation and presentation of search results using addressing information, in accordance with an embodiment of the present invention. As indicated by an arrow 361, a web browser 201 may provide a document request to a web server computer 102A. In the example of FIG. 3, the document request is a request to receive a web page. However, the document request may also be a request to receive a program, a file, a connection, or other types of information, data, or service accessible over a computer network such as the Internet. In response to the document request, web server computer 102A may provide the requested web page to client computer 101 (see arrow 362). Web browser 201 may display the requested web page in a browser window 373 displayed in a computer screen 372 of client computer 101.

A message delivery program 200 may monitor an end-user's browsing activity by listening for addressing information from web browser 201. For example, message delivery program 200 may receive an event notification (see arrow 363) from web browser 201 every time the end-user navigates, such as when the user navigates from one website to another website, or to specific web pages of a website. An event notification may include addressing information, such as a URL. Thus, message delivery program 200 receives from web browser 201 the URL of the web page requested from web server computer 102A. As can be appreciated, the mechanics of monitoring an end-user's browsing activity, such as determining where an end-user is navigating to, what an end-user is typing on a web page, when an end-user activates a link, when an end-user uses a mouse or keyboard, and the like, is, in general, known in the art.

Upon receipt of a URL from web browser 201, message delivery program 200 may send a request packet to message server computer 103 (see arrow 364). The request packet my include the URL, thus identifying to message server computer 103 where the end-user just navigated. For example, if the end-user received a web page from “travellingtoday.com”, a fictitious travel-related website, message server computer 103 may receive the URL “http://www.travellingtoday.com” in the request packet.

As shown in FIG. 3, message server computer 103 may include one or more message units 301 and a database 310. Database 310 may keep track of message units 301 intended for websites belonging to a certain category of websites. For example, a message unit 301A (a specific embodiment of a message unit 301) may be designated for travel-related websites, such as “travellingtoday.com”, “cruiseandsnooze.com”, “faroffandaway.com”, and other websites. Thus, when a request packet indicates that the end-user is viewing a particular web page of “travellingtoday.com”, message server computer 103 may consult database 310 for any message units 301 intended for “travellingtoday.com”, which in this example is message unit 301A. Message server computer 103 may then provide message unit 301A to client computer 101 (see arrow 365).

Message server computer 103 may also consult database 310 for one or more keywords associated with the URL included in a received packet. For example, if a request packet indicates that the end-user is viewing a web page of “travellingtoday.com” and the keyword “travel” has been assigned to travel-related websites like “travellingtoday.com”, a search may be performed on the keyword “travel”. The search may be performed by a search engine resident in message server computer 103, in another server computer working with message server computer 103, or in a web server computer accessible over the Internet. In the example of FIG. 3, the keyword is provided to a web server computer 102B accessible over the Internet (see arrow 366). Web server computer 102B may be operated by one business entity, while message server computer 103 may be operated by another business entity. This advantageously allows for revenue sharing for each search results provided to the end-user. For example, search results provided to the end-user may contain paid advertisements. The revenue from the paid advertisement may be shared between the operator of message server computer 103, operator of web server computer 102B, and provider of message delivery program 200.

As shown in FIG. 3, web server computer 102B may include a search engine 370 for performing an Internet search or a local search. As can be appreciated, search engine 370 may also be a database containing a predetermined list of advertisements and information. For example, search engine 370 may be a database containing a predetermined list of hyperlinks to travel-related websites, which may or may not be in competition to the travel-related website the end-user just visited (“travellingtoday.com” in this example). A search engine 370 comprising a database containing a predetermined list of advertisements and information may also be resident in message server computer 103, or client computer 101 depending on the size of the search engine. The location and functionalities of a search engine may be varied from description provided herein without detracting from the merits of the present invention.

In the example of FIG. 3, search engine 370 performs a search on the keyword provided by message server computer 103, and posts the search results on a web page 371 (see arrow 367). Web page 371 may be resident in a web server accessible over the Internet, such as web server computer 102B or message server computer 103, for example. The address of web page 371 may be included in a corresponding message unit (message unit 301A in the travel-related website example) provided to client computer 101. A presentation vehicle 374 displayed in computer screen 372 may thus be pointed to web page 371 to display the search results. In one embodiment, presentation vehicle 374 comprises a browser window displayed under browser window 373. That is, presentation vehicle 374 may be a pop-under. As can be appreciated, the search results may also be integrated in browser window 373 (e.g., displayed in a side panel of browser window 373), or displayed in other types of presentation vehicles.

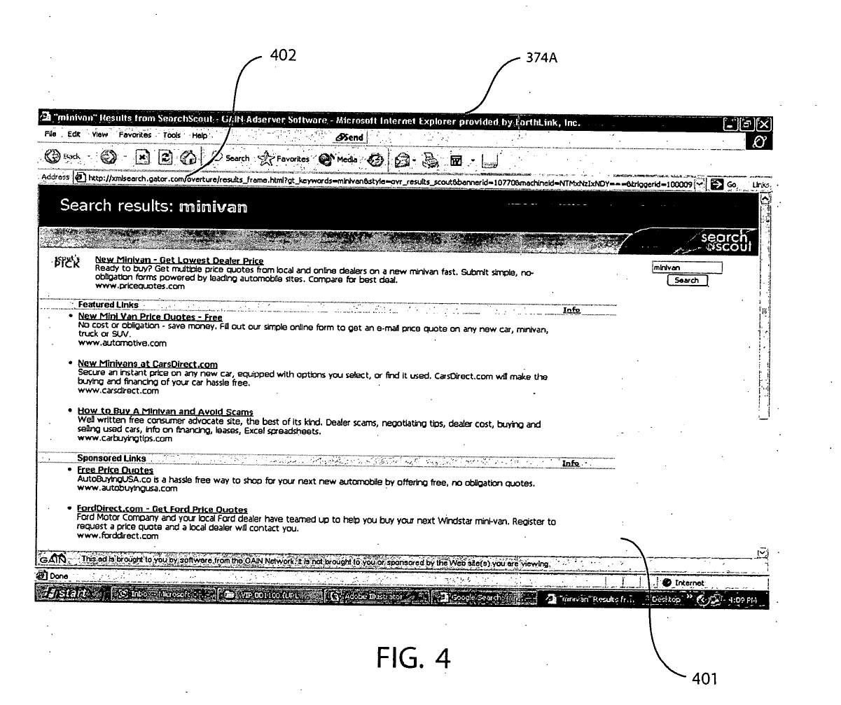

FIG. 4 shows a presentation vehicle 374A for displaying search results 401 in accordance with an embodiment of the present invention. Presentation vehicle 374A is a specific embodiment of presentation vehicle 374 shown in FIG. 3. Presentation vehicle 374A may be a browser window displayed as a pop-under. In the example of FIG. 4, presentation vehicle 374A is pointed to a URL 402 of a web page containing search results for the keyword “minivan”. Presentation vehicle 374A and the displayed search results 401 may be in response to the end-user navigating to the minivan web page of the fictitious domain “cars.com”, for example.

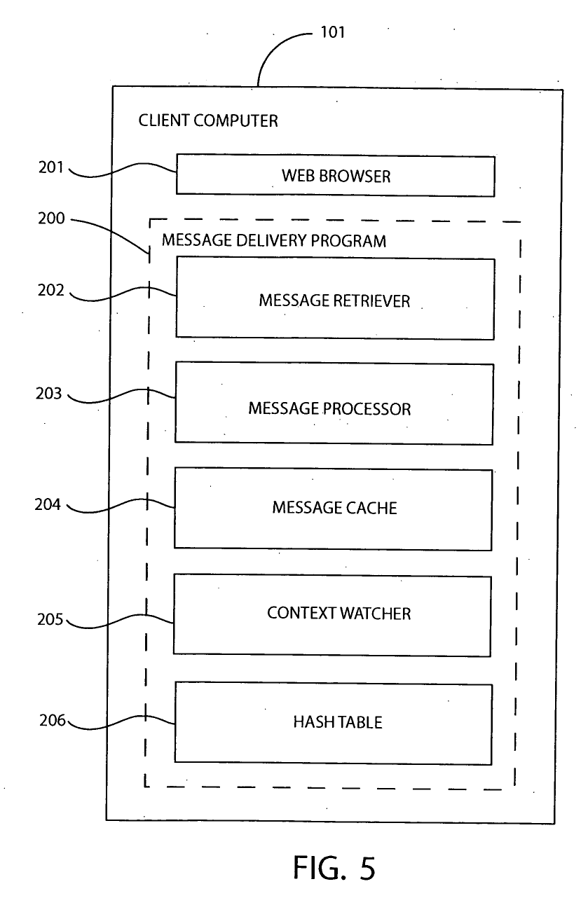

FIG. 5 schematically illustrates the components of a client computer 101 in accordance with an embodiment of the present invention. In one embodiment, the components of client computer 101 shown in FIG. 5 are implemented in software. It should be understood, however, that components in the present disclosure may be implemented in hardware, software, or a combination of hardware and software (e.g., firmware). Software components may be in the form of computer-readable program code stored in a computer-readable storage medium such as random access memory (RAM), mass storage device (e.g., local hard disk drive or remote hard disk drive accessible over the Internet), or removable storage device (e.g., optical storage device such as a CD-ROM or DVD). For example, a computer-readable storage medium may comprise computer-readable code for performing the function of a particular component. Likewise, computer memory may be configured to include one or more components, which may then be run by a microprocessor. Components may be implemented separately in multiple modules or together in a single module.

As shown in FIG. 5, client computer 101 may include a web browser 201 and a message delivery program 200. Web browser 201 may be a commercially available web browser or web client running on a client computer 101. In one embodiment, web browser 201 is the Microsoft Internet Explorer™ web browser.

In one embodiment, message delivery program 200 is downloadable from a message server computer 103. Message delivery program 200 may be downloaded in conjunction with the downloading of another computer program. For example, message delivery program 200 may be downloaded to a client computer 101 along with a utility program that is provided free of charge or at a reduced cost. The utility program may be provided to an end-user in exchange for the right to deliver messages to the end-user via message delivery program 200. In essence, revenue (e.g., advertising fees) from messages delivered to the end-user may help defray the cost of creating and maintaining the utility program.

Message delivery program 200 may include a message retriever 202, a message processor 203, a message cache 204, a context watcher 205, and a hash table 206. Other components such as operating system components, utility programs, application programs, and the like are not shown for clarity of illustration.

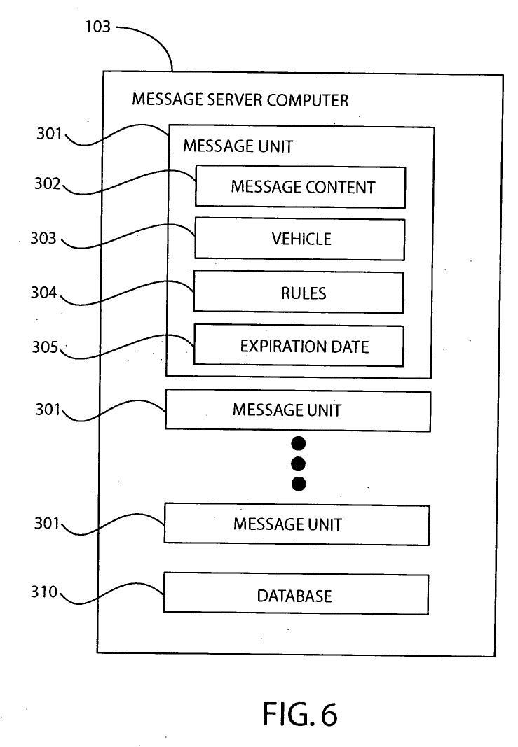

Message retriever 202 may include computer-readable program code for requesting message units from message server computer 103. As will be explained later on in connection with FIG. 6, a message unit may include a message content. A message content may include, without limitation, information to be displayed on a computer screen, audio to be played, or computer-readable program code (e.g., Java applet, script, HTML, hyperlink, pointer to a web page containing search results). Message units are processed according to their message contents. For example, a message unit containing displayable message content is processed by displaying its message content on a computer screen, a message unit whose message content includes computer-readable program code is processed by running its message content, and so on.

Still referring to FIG. 5, message retriever 202 monitors web browser 201 for the uniform resource locator (URL) of websites visited by an end-user navigating on the Internet. For each website visited by an end-user, message retriever 202 may send a request packet to message server computer 103. In one embodiment, a request packet includes:
(a) the end-user's unique identification (ID) number;
(b) the ID number of client computer 101;
(c) the local time;
(d) the domain name of the website visited by the end-user; and
(e) a list of message units stored in message cache 204.

In one embodiment, personal information such as the actual name of the end-user, credit card information, residence address, and the like is stored solely in client computer 101 to protect the end-user's privacy.

Message server computer 103 checks if there is a corresponding message unit for each request packet received from client computer 101. If so, message server computer 103 sends the corresponding message unit to client computer 101. For example, message retriever 202 may send a request packet to message server computer 103 as an end-user navigates from “travellingtoday.com” to “cars.com.” If a message unit is available for the domain “cars.com”, message server computer 103 will send that message unit to client computer 101. Message units received in client computer 101 are stored in message cache 204.

Client computer 101 may also include a hash table 206. Hash table 206 may contain information for determining whether a message unit is available for a particular domain. This allows message retriever 202 to first query hash table 206 before sending a request packet to message server computer 103. If hash table 206 indicates that there is a message unit for a domain visited by the end-user, message retriever 202 may proceed to send a request packet to message server computer 103. Otherwise, message retriever 202 may not send a request packet, thereby minimizing the amount of request packets sent to and processed by message server computer 103.

Message processor 203 may include computer-readable program code for processing a message unit. Message processor 203 may process a message unit by displaying its message content. Message processor 203 may display a message content using a variety of presentation vehicles including pop-ups, pop-unders, banners, message boxes, text boxes, sliders, separate windows, windows embedded in a web page, and other mechanisms for displaying information. Message processor 203 may also process a message unit by playing its message content if the message content is audio or video, or by running its message content if the message content is computer-readable program code. Message processor 203 may process a message unit by displaying a pop-under (or other presentation vehicle) pointed to a web page containing search results. Specifically, message processor 203 may request web browser 201 to open a new browser window to display the web page containing the search results.

Context watcher 205 may include computer-readable program code for determining if a message unit has been triggered for processing. Context watcher 205 checks message cache 204 for message units whose rules have been satisfied. If context watcher 205 finds such a message unit, context watcher 205 alerts message processor 203 to process the message unit. Rules for processing message units are further described with reference to FIG. 6.

FIG. 6 schematically illustrates the components of a message server computer 103 in accordance with an embodiment of the present invention. As mentioned, message server computer 103 receives request packets from a client computer 101. Each received request packet may include the domain name of the website visited by an end-user. Message server computer 103 uses the domain name to find all message units available for that website. For example, a message unit may contain an advertisement for a car company that wants to display its advertisement to end-users visiting car-related websites, such as “cars.com”. When a request packet indicates that an end-user is on “cars.com”, the message unit containing the car company's advertisement will be sent to the requesting client computer 101.

A message server computer 103 may include one or more message units 301 and a database 310. Database 310 may be a commercially available database program. Database 310 may be employed to keep track of message units 301. For example, message server computer 103 may query database 310 for all message units 301 available for a particular website.

A message unit 301 may include a message content 302, a vehicle 303, rules 304, and an expiration date 305. Message content 302 may include computer-readable program code, text, images, audio, video, hyperlink, and other information. A message content 302 may be an advertisement, or a pointer to a web page designated to contain search results, for example.

Vehicle 303 indicates the presentation vehicle to be used in presenting message content 302 to an end-user. For example, vehicle 303 may call for the use of a pop-up, pop-under, banner, message box, text box, slider, separate window, window embedded in a web page, and the like

A message unit 301 may include rules 304 for specifying the conditions that need to be satisfied before the message unit is triggered for processing. Rules 304 may specify to display a message content 302 when an end-user navigates to a specific web page or as soon as the message unit 301 is received in a client computer 101. For example, a car company may contract with the operator of a message server computer 103 to deliver a message unit 301B containing an advertisement for a minivan (message unit 301B is a specific embodiment of a message unit 301). The rules 304 of message unit 301B may specify that the minivan advertisement is to be displayed to end-users viewing the minivan web page of “cars.com”. In this example, the minivan web page of cars.com has the URL “www.cars.com/minivans”. When an end-user visits the main page (or any web page) of =37 cars.com”, message retriever 202 (see FIG. 5) will send a request packet to message server computer 103 indicating that the end-user is on “cars.com”. In response, message server computer 103 will send message unit 301B to client computer 101. When the end-user navigates to the URL “www.cars.com/minivans”, context watcher 205 will detect that the minivan message unit has been triggered for display (i.e., rules 304 of message unit 301B have been satisfied). Context watcher 205 will accordingly inform message processor 203, which will then process message unit 301B by displaying (or initiating the display of) its message content.

In the above described minivan example, message unit 301B may also be commissioned by a search engine that accepts paid advertising for inclusion in search results. Accordingly, the message content of message unit 301B may be a pointer to a web page designated to contain search results for the keyword “minivan”. Thus, when an end-user navigates to “www.cars.com/minivans”, search results for the keyword “minivan” from the commissioning search engine may be displayed in a pop-under pointed to the designated web page.

Rules 304 may also include: (a) a list of domain names at which the content of a message unit 301 is to be displayed, (b) URL sub-strings that will trigger displaying of the content of the message unit 301, and (b) time and date information. As can be appreciated, rules 304 may also be extended to take into account additional information relating to an end-user (as identified by a corresponding end-user ID) such as the end-user's frequent flyer affiliation, club memberships, type of credit card used, hobbies and interests, and basic demographic information. End-user related information may be stored in client computer 101 or database 310 of message server computer 103. End-user related information may be used for targeted advertising purposes, for example.

As shown in FIG. 6, a message unit 301 may also include an expiration date 305. Expiration date 305 indicates the latest date and time the message unit 301 can still be processed. Expired message units 301 do not have to be processed and may be removed from client computer 101.

Other techniques for receiving and processing message units are also described in the following commonly-assigned disclosure, which is incorporated herein by reference in its entirety: U.S. application Ser. No. 10/152,204, filed on May 21, 2002, by Scott G. Eagle, David L. Goulden, Anthony G. Martin, and Eugene A. Veteska.

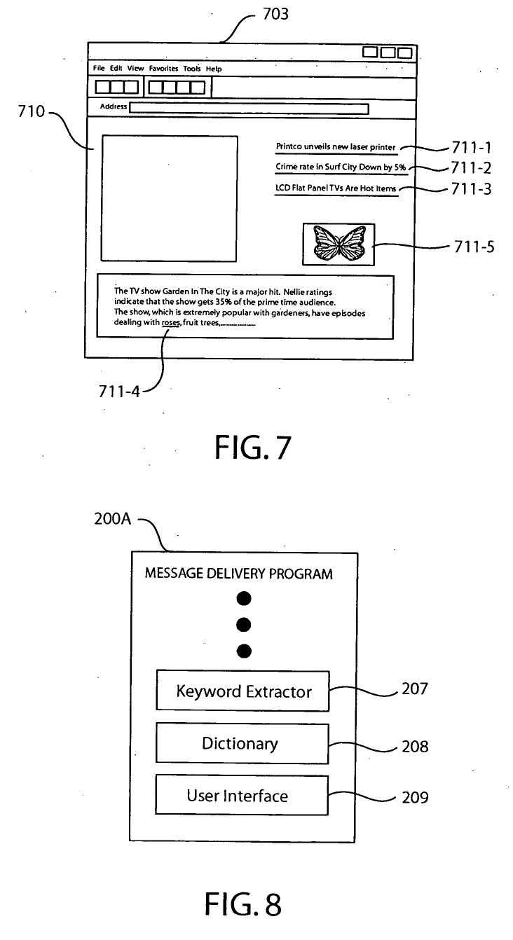

In another aspect of the present invention, search results are generated in a computer network by detecting an end-user interaction with a document, generating a keyword based on the end-user interaction with the document, and performing a search using the keyword. The computer network may include the Internet and the document may be a web page. For example, a message delivery program running on a client computer may monitor the end-user's browsing activities on the Internet. When the end-user clicks on a link on a web page, information associated with the link, such as the link's label, may be parsed to generate one or more keywords. The keywords may be used to perform a search to generate search results responsive to the keywords. This aspect of the present invention is now discussed beginning with FIG. 7.

FIG. 7 shows an example document available over a computer network. In the example of FIG. 7, the document comprises a web page 710 displayed in a browser window 703. Web page 710 may include typical web page features, such as text, images, links, and the like. In the example of FIG. 7, web page 710 includes links 711 (i.e., 711-1, 711-2, . . . ). Generally speaking, an end-user may activate a link on a document to go to another portion of the document or to another document altogether. Here, the end-user may activate a link 711 to go to another portion of web page 710 or to another web page accessible over the Internet. The end-user may activate a link 711 by clicking (e.g., single or double clicking) on the link using a pointing device, such as a mouse, trackball, or touchpad, for example.

A link 711 may have a corresponding viewable portion referred to herein as a “label.” The label defines a region that may be clicked on to activate the link. The label may comprise textual data as in the case of links 711-1, 711-2, 711-3, and 711-4, or image data (e.g., photo, graphics) as in the case of link 711-5. The label may be a subject line clickable to see the full story as in the case of links 711-1, 711-2, and 711-3, or clickable texts within a story as in the case of link 711-4. The label is typically what attracts the end-user to activate the link. Some embodiments of the present invention take advantage of this by generating one or more keywords based on the label. The keywords derived from the label may then be employed to generate search results that are relevant to the end-user's current interest, manifested by activating the link.

FIG. 8 schematically illustrates the components of a message delivery program 200A in accordance with an embodiment of the present invention. Message delivery program 200A is the same as message delivery program 200 (see FIG. 5) except for the addition of a keyword extractor 207, a dictionary 208, and a user interface 209.

A keyword extractor 207 may comprise computer-readable program code for parsing a label to extract one or more keywords. The keyword extractor 207 may employ regular expressions and pattern matching techniques. In one embodiment, the keyword extractor 207 uses the dictionary 208 in filtering the contents of a label. The dictionary 208 may comprise a data structure, listing, table, database or other data storage and retrieval mechanism. In one embodiment, the dictionary 208 contains noise words, stop words, popular words, and commercial words. Noise words include words that are not taken into account by most search engines, such as articles (e.g., “a”, “an”, “the”) and prepositions, for example. Stop words, also referred to as “blacklisted words,” are those that have been designated as not to be searched. As can be appreciated, stop words will vary depending on implementation. Examples of words that may be designated as stop words include pornographic words and racial slurs. Popular words include those frequently used by end-users to perform searches. Lists of popular words may be obtained from surveys, search engines, studies, and the like. Commercial words include those that have commercial value, such as trademarks, goods (e.g., TV, PC, computer, washing machines, laser printer, inkjet printer, SUV, sedan), company names, domain names, website names, and the like. Some commercial words may also qualify as popular words, and vice-versa.

In one embodiment, the keyword extractor 207 consults the dictionary 208 to identify noise words, stop words, popular words, and commercial words that may be contained in a label. The keyword extractor 207 may first remove identified noise words and stop words from the label (and not use any of them for search purposes) to make the label easier to parse. The keyword extractor may then extract popular words and commercial words from the label for use as keywords in a subsequently performed search. The keyword extractor 207 may also extract words that are not stop words or noise words as keywords for search purposes. For example, using link 711-1 as an example (see FIG. 7), the keyword extractor 207 may parse the label “Printco unveils new laser printer” to extract the keywords “Printco” and “laser printer.” The keywords “Printco laser printer” may be provided to a search engine to generate search results.

The dictionary 208 may also include a table that lists predetermined substitutes for various words. This allows the keyword extractor 207 to consult the dictionary 208 to find substitute keywords. For example, the dictionary 208 may have a table that lists particular words in one column and corresponding substitute keywords in another column. When the keyword extractor 207 extracts a word included in the table, the keyword extractor 207 may designate a corresponding substitute as keywords. As a specific example, the dictionary 208 may include a Table 1 shown below:

TABLE 1

| Word(s) | Substitute Keywords |
|---|---|
| Kona coast | Hawaii Vacation Packages |
| Maui beach | Hawaii Vacation Packages |
| Hertz | Car rentals |
| Hertz | Car rentals |

In the example of Table 1, the keyword extractor 207 finding the words “Kona coast” or “Maui beach” in a link label may instead designate “Hawaii Vacation Packages” as keywords. The substitute keywords, “Hawaii Vacation Packages” in this example, may then be provided to a search engine to generate search results.

In one embodiment, the keyword extractor 207 may prioritize the extracted keywords to limit the search. For example, the keyword extractor 207 may only extract popular and commercial words as keywords. In yet another embodiment, the keyword extractor 207 simply takes the entire label as keywords for search purposes. Using link 711-3 as an example (see FIG. 7), the keyword extractor 207 may designate the entire label, which is “LCD Flat Panel TVs are Hot Items,” as keywords. That is, the keyword extractor 207 may designate the entire label or any number of words from the label as keywords without detracting from the merits of the present invention.

In situations where the label comprises an image, as in the case of link 711-5, the keyword extractor 207 may search the web page for textual data related to the image, such as an adjacent blurb or title, name of the image file, or non-viewable textual information about the image (e.g., comment in the HTML code of the web page). As in textual labels, the keyword extractor 207 may designate the entire textual data related to the image or portions of it as keywords.

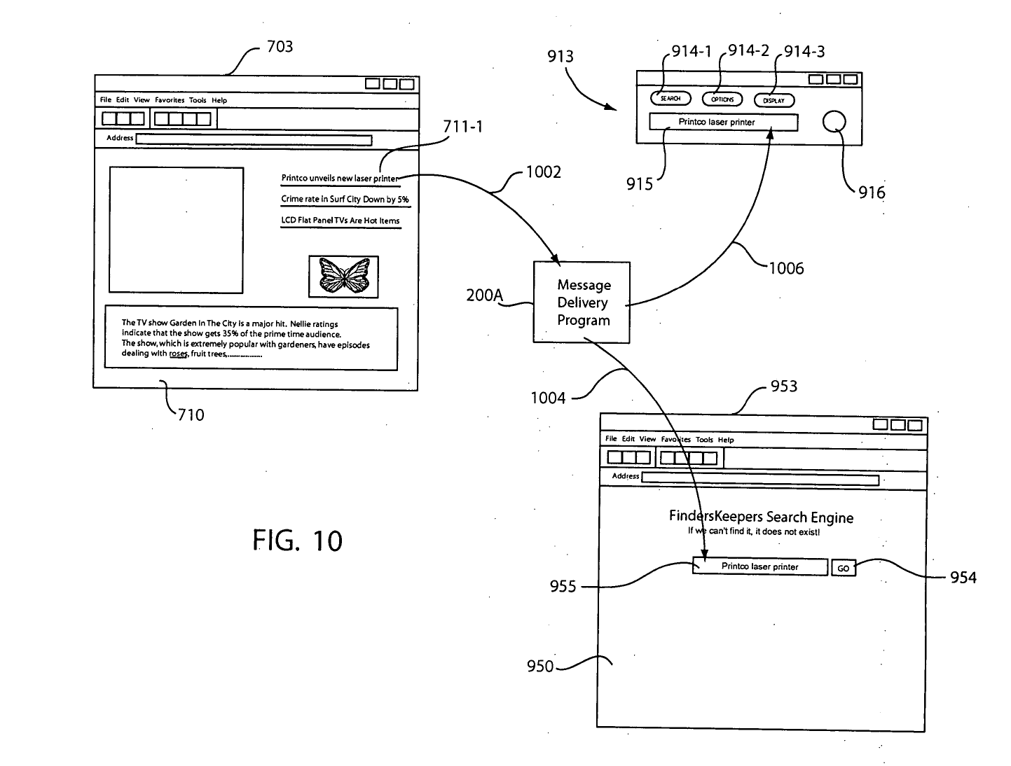

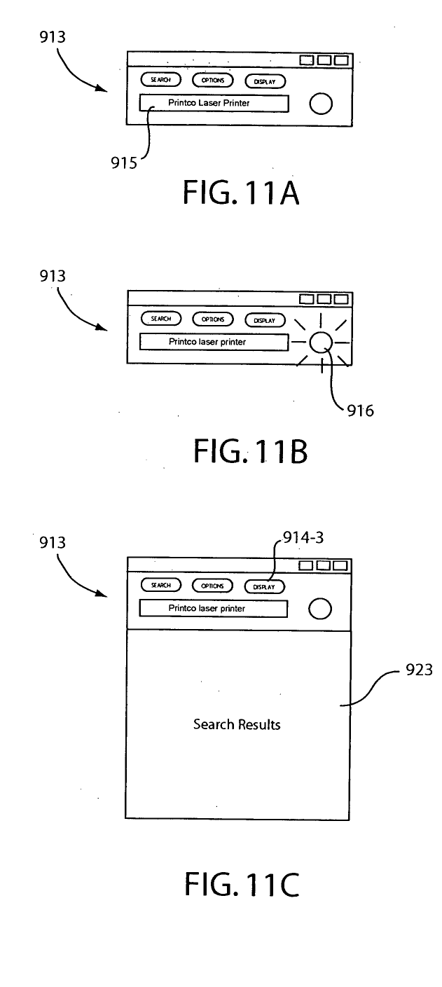

Referring to FIG. 8, the user interface 209 may comprise computer-readable program code for allowing the end-user to configure and operate particular portions of message delivery program 200A. In one embodiment, the user interface 209 comprises a toolbar 913, later discussed with reference to FIGS. 10 and 11. The user interface 209 may interoperate with other components of message delivery program 200A to communicate with remote search engines or message server computers 103. For example, keywords provided to the user interface 209 may be sent to a message server computer as part of a request packet. The message server computer may forward the keywords to a search engine, which may then perform a search using the keywords and post responsive search results on a web page. The message server computer may provide the address of the web page to the user interface 209 as part of a message unit. The user interface 209 may point a browser window to the web page to display the search results to the end-user. Other means of providing keywords to search engines and displaying search results responsive to the keywords may also be employed without detracting from the merits of the present invention.

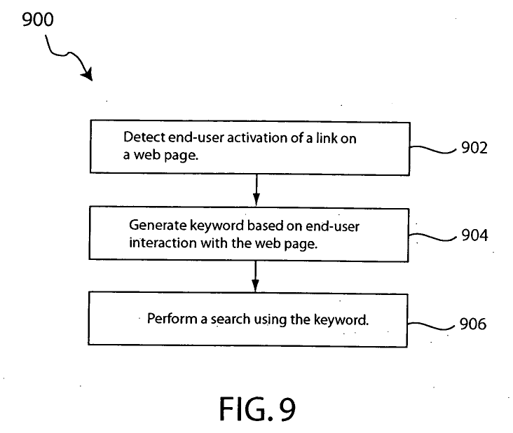

FIG. 9 shows a flow diagram of a method 900 of performing a search in a computer network in accordance with an embodiment of the present invention. In step 902, a message delivery program resident in a client computer detects and end-user activation of a link on a web page. The end-user may activate the link by clicking on it, for example. In step 904, the message delivery program may generate one or more keywords based on the end-user activation of the link. For example, the message delivery program may selectively extract words from a label of the link and designate them as keywords. The message delivery program may also designate the entire label of the link as keywords. In step 906, the keywords generated by the message delivery program are used to perform a search. The search may be over the Internet. The keywords generated by the message delivery program may be provided to a remote search engine to generate search results. For example, the message delivery program may open a browser window pointed to a web page of a search engine. The message delivery program may then populate an input field of the search engine with the keywords. As another example, the message delivery program may populate an input field of a toolbar configured to perform searches.

FIG. 10 shows a flow diagram illustrating generation of keywords for searching in a computer network, in accordance with an embodiment of the present invention. In the example of FIG. 10, an end-user activates link 711-1 of web page 710 (see FIG. 7). Web page 710 is in browser window 703, which may be displayed on the computer screen of the client computer employed by the end-user. Message delivery program 200A, which is running in the client computer employed by the end-user, detects the end-user's activation of link 711-1 (see arrow 1002). In response, message delivery program 200A generates one or more keywords based on the end-user activation of link 711-1. In the example of FIG. 10, message delivery program 200A selectively extracts, and designates as keywords, the words “Printco laser printer” from the label of link 711-1. In other embodiments, message delivery program 200A uses the entire label (e.g., “Printco unveils new laser printer”) as keywords.

Message delivery program 200A may open a browser window 953 that is pointed to a web page 950 of a search engine, such as Yahoo! and Google, for example. Message delivery program 200A may use the keywords derived from the end-user activation of link 711-1 to populate an input field 955 of the web page 950 of the search engine (see arrow 1004). This allows the end-user to click on the “GO” button 954 of the web page 950 to initiate a search using the keywords. Browser window 953 and a web page comprising search results responsive to the keywords may be displayed as a pop-under (e.g., underneath browser window 703 on the end-user's computer screen).

Message delivery program 200A may also use the keywords derived from the end-user activation of link 711-1 to populate an input field 915 of a toolbar 913 (see arrow 1006). Toolbar 913 may be part of the user interface 209 (see FIG. 8) program code of message delivery program 200A. Toolbar 913 may be displayed on the end-user's computer screen as a separate window or as an integrated portion of a browser window. Toolbar 913 may include buttons 914 (i.e. 914-1, 914-2, 914-3) and an indicator 916. In the example of FIG. 10, activating button 914-1 initiates a search using the keywords in input field 915. Message delivery program 200A may provide the keywords shown in input field 915 to a remote search engine, which generates search results responsive to the keywords. Activating button 914-3 displays the search results. The search results may be displayed in a browser window integrated with or separate from toolbar 913. Indicator 916 provides a visual indicator as to whether search results are available for the keywords of input field 915. That is, indicator 916 alerts the end-user when search results are available for display.

In one embodiment, button 914-2 opens a menu (not shown) allowing the end-user to disable/enable features of message delivery program 200A. For example, activating button 914-2 may open a menu for enabling or disabling automatic searches. That is, toolbar 913 may be configured to initiate a search using keywords in input field 915 without the end-user having to activate button 914-1. As another example, activating button 914-2 may open a menu for enabling or disabling automatic displaying of search results. That is, tool bar 913 may be configured to automatically display search results without waiting for the end-user to activate button 914-3.

FIGS. 11A, 11B, and 11C pictorially illustrates the generation of search results in accordance with an embodiment of the present invention. In FIG. 11A, input field 915 of toolbar 913 is populated with keywords derived from end-user interaction with a link. In this example, toolbar 913 has been configured to automatically perform a search whenever a new keyword is entered in input field 915. Thus, when input field 915 is populated with the keywords, toolbar 913 automatically sends the keywords to a search engine accessible over the Internet. Once search results responsive to the keyword have been generated by the search engine, the search engine may so notify toolbar 913. The search engine may post the search results on a web page 923 having an address that is pre-determined or provided to toolbar 913 (i.e., message delivery program 200A). In response, as shown in FIG. 11B, toolbar 913 may flash indicator 916 to alert the end-user that search results responsive to the keywords are available for display. Assuming automatic displaying of search results is disabled, the end-user may activate button 914-3 to display the search results. In response, toolbar 913 may open a window pointed to the address of web page 923. Web page 923, which has the search results, is shown in the example of FIG. 11C as being integrated with toolbar 913. Web page 923 may also be displayed in a browser window separate from toolbar 913.

While specific embodiments of the present invention have been provided, it is to be understood that these embodiments are for illustration purposes and not limiting. Many additional embodiments will be apparent to persons of ordinary skill in the art reading this disclosure. Thus, the present invention is limited only by the following claims.

1. A method of performing a search in a computer network, the method to be performed by a computer and comprising:
detecting an end-user interaction with a document;
automatically generating a keyword based on the end-user interaction; and
initiating a search using the keyword.

2. The method of claim 1 wherein detecting the end-user interaction with the document comprises:
detecting when the end-user activates a link on a web page obtained over the Internet.

3. The method of claim 2 wherein automatically generating the keyword based on the end-user interaction comprises:
parsing a label of the link to extract the keyword.

4. The method of claim 1 wherein initiating the search using the keyword comprises:
populating an input field of a user interface with the keyword.

5. The method of claim 4 wherein the user interface comprises a toolbar.

6. The method of claim 1 wherein initiating the search using the keyword comprises:
populating an input field of a web page of a search engine.

7. The method of claim 1 further comprising:
providing the consumer search results responsive to the keyword.

8. The method of claim 7 wherein the search results are posted on a pop-under.

9. The method of claim 1 wherein generating the keyword based on the end-user interaction comprises:
receiving a label of a link activated by the end-user; and
filtering the label to extract the keyword.

10. The method of claim 9 wherein filtering the label to extract the keyword comprises:
removing noise words from the label.

11. The method of claim 9 wherein filtering the label to extract the keyword comprises:
removing stop words from the label.

12. The method of claim 9 wherein filtering the label to extract the keyword comprises:
identifying popular search words in the label.

13. The method of claim 9 wherein filtering the label to extract the keyword comprises:
identifying a particular word in the label; and
finding a substitute keyword for the particular word.

14. The method of claim 1 wherein detecting the end-user interaction with the document is performed by computer-readable program code running in a client computer employed by the end-user.

15. A computer-readable storage medium comprising:
computer-readable program code for detecting an end-user activation of a link on a web page;
computer-readable program code for generating a keyword based on the end-user activation of the link; and
computer-readable program code for initiating a search over the Internet using the keyword.

16. The computer-readable storage medium of claim 15 wherein the end-user activation of the link includes clicking on the link using a mouse cursor.

17. The computer-readable storage medium of claim 15 further comprising:
computer-readable program code for generating search results responsive to the keyword.

18. The computer-readable program code of claim 15 wherein the keyword is generated by extracting the keyword from a label of the link.

19. A method of performing a search in a computer network, the method to be performed by a computer and comprising:
detecting an end-user activation of a link on a web page;
parsing textual data associated with the link to generate a keyword; and using the keyword to perform an Internet search.

20. The method of claim 19 further comprising:
generating search results responsive to the keyword.

21. The method of claim 19 wherein the textual data comprises a label of the link.

22. The method of claim 21 wherein parsing the textual data comprises:
filtering noise words from the label.

23. The method of claim 21 wherein parsing the textual data comprises:
filtering stop words from the label.

24. The method of claim 21 wherein parsing the textual data comprises:
identifying popular search words from the textual data.

25. The method of claim 21 wherein parsing the textual data comprises:
identifying a particular word in the label; and
finding a substitute keyword for the particular word.

26. A system for performing a search in a computer network, the system comprising:
a client computer running a client program configured to detect an end-user activation of a link on a document; and
a server computer configured to generate search results responsive to a keyword generated based on the end-user activation of the link.

27. The system of claim 26 wherein the server computer receives the keyword from the client computer.

28. The system of claim 26 wherein the document comprises a web page.

29. The system of claim 26 wherein the keyword is generated by parsing a label associated with the link.

30. The system of claim 26 wherein the client computer includes a message delivery program configured to monitor the end-user's browsing activity.
